(19) United States
(12) Patent Application Publication
(10) Pub. No.: US 2024/0256827 A1
(43) Pub. Date: Aug. 1, 2024

(54) ACTIVATION BUFFER ARCHITECTURE FOR DATA-REUSE IN A NEURAL NETWORK ACCELERATOR

(71) Applicant: QUALCOMM Incorporated, San Diego, CA (US)

(72) Inventors: Sameer WADHWA, San Diego, CA (US); Suren MOHAN, San Diego, CA (US); Peiyu ZHU, Luzhou (CN); Ren LI, San Diego, CA (US); Ankit SRIVASTAVA, San Diego, CA (US); Seyed Arash MIRHAJ, Poway, CA (US)

(21) Appl. No.: 18/565,414

(22) PCT Filed: Jul. 27, 2021
(86) PCT No.: PCT/CN2021/108594

§ 371 Date: Nov. 29, 2023

(51) Int. Cl. G06N 3/04

(52) U.S. Cl. CPC G06N 3/04

(57) ABSTRACT

Certain aspects provide an apparatus for signal processing in a neural network. The apparatus generally includes computation circuitry configured to perform a convolution operation, the computation circuitry having multiple input rows, and an activation buffer having multiple buffer segments coupled to the multiple the multiple input rows of the computation circuitry, respectively. In some aspects, each of the multiple buffer segments comprises a first multiplexer having a plurality of multiplexer inputs, and each of the plurality of multiplexer inputs of one of the first multiplexers on one of the multiple buffer segments is coupled to a data output of the activation buffer on another one of the multiple buffer segments.

### INTRODUCTION

Aspects of the present disclosure relate to performing machine learning tasks and in particular to organization of data for improved machine learning processing efficiency.

Machine learning is generally the process of producing a trained model (e.g., an artificial neural network, a tree, or other structures), which represents a generalized fit to a set of training data. Applying the trained model to new data produces inferences, which may be used to gain insights into the new data. In some cases, applying the model to the new data is described as “running an inference” on the new data.

As the use of machine learning has proliferated for enabling various machine learning (or artificial intelligence) tasks, the need for more efficient processing of machine learning model data has arisen. In some cases, dedicated hardware may be used to enhance a processing system's capacity to process machine learning model data. However, such hardware requires space and power, which is not always available on the processing device. Accordingly, systems and methods are need for improving power efficiency associated neural network systems.

### BRIEF SUMMARY

Certain aspects provide an apparatus for signal processing in a neural network. The apparatus generally includes computation circuitry configured to perform a convolution operation, the computation circuitry having multiple input rows, and an activation buffer having multiple buffer segments coupled to the multiple input rows of the computation circuitry, respectively. In some aspects, each of the multiple buffer segments comprises a first multiplexer having a plurality of multiplexer inputs, and each of the plurality of multiplexer inputs of one of the first multiplexers on one of the multiple buffer segments is coupled to a data output of the activation buffer on another one of the multiple buffer segments.

Certain aspects provide an apparatus for signal processing in a neural network. The apparatus generally includes computation circuitry configured to perform a convolution operation, the computation circuit having multiple input rows, and an activation buffer having multiple buffer segments coupled to the multiple input rows of the computation circuitry, respectively. In some aspects, the activation buffer comprises a multiplexer having multiplexer inputs coupled to multiple input nodes of the multiple buffer segments and multiplexer outputs coupled to multiple output nodes of the multiple buffer segments. The multiplexer may be configured to selectively couple each input node, on one of the multiple buffer segments, of the multiple input nodes to one of the multiple output nodes on another one of multiple buffer segments to perform a data shift between the multiple buffer segments, and the activation buffer may be further configured to store a buffer offset indicating a quantity of currently active data shifts associated with the multiplexer.

Certain aspects provide a method for signal processing in a neural network. The method generally includes receiving, at multiple input rows of computation circuitry, a first plurality of activation input signals from data outputs of an activation buffer, the activation buffer having multiple buffer segments coupled to the multiple input rows of the computation circuitry, respectively. The method also includes performing, via the computation circuitry, a first convolution operation based on the first plurality of activation input signals, and shifting, via the activation buffer, data stored at the data outputs of the activation buffer, wherein shifting the data comprises selectively coupling each of a plurality of multiplexer inputs of a multiplexer on one of the multiple buffer segments to the data output of the activation buffer on another one of the multiple buffer segments. The method may also include receiving, at the multiple input rows of the computation circuitry, a second plurality of activation input signals from the data outputs after the shifting of the data; and performing, via the computation circuitry, a second convolution operation based on the second plurality of activation input signals.

Certain aspects provide a method for signal processing in a neural network. The method generally includes receiving, at multiple input rows of computation circuitry, a plurality of activation input signals from multiple output nodes of an activation buffer, the activation buffer having multiple buffer segments coupled to the multiple input rows of the computation circuitry, respectively. The method may also include performing, via the computation circuitry, a first convolution operation based on the first plurality of activation input signals, wherein the activation buffer comprises a multiplexer having multiplexer inputs coupled to multiple input nodes on the multiple buffer segments and multiplexer outputs coupled to the multiple output nodes. The method may also include shifting, via the multiplexer of the activation buffer, data stored at the multiple output nodes based on a buffer offset indicating a quantity of currently active data shifts associated with the multiplexer, wherein the shifting comprises selectively coupling each input node, on one of the multiple buffer segments, of the multiple input nodes to one of the multiple output nodes on another one of multiple buffer segments, receiving, at the multiple input rows of the computation circuitry, a second plurality of activation input signals from the multiple output nodes after the shifting of the data, and performing, via the computation circuitry, a second convolution operation based on the second plurality of activation input signals.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict some aspects of the present disclosure and are therefore not to be considered limiting of the scope of this disclosure.

FIGS. 1A-1D depict examples of various types of neural networks.

FIG. 2 depicts an example of a conventional convolution operation.

FIGS. 3A and 3B depicts examples of depthwise separable convolution operations.

FIG. 4 illustrates an example computation in memory (CIM) array configured for performing machine learning model computations.

FIG. 5 illustrates a processing system having circuitry for data reuse, in accordance with certain aspects of the present disclosure.

FIG. 6 is a flow diagram illustrating example operations for signal processing in a neural network, in accordance with certain aspects of the present disclosure.

FIGS. 7A and 7B illustrates a neural network system having an activation buffer configured for performing shift of data between data rows using a multiplexer, in accordance with certain aspects of the present disclosure.

FIG. 8 is a flow diagram illustrating example operations for signal processing in a neural network, in accordance with certain aspects of the present disclosure.

FIGS. 9A and 9B illustrate example activation inputs associated with x and y dimensions of a neural network input, in accordance with certain aspects of the present disclosure.

FIG. 9C illustrates an activation buffer having packing conversion circuitry, in accordance with certain aspects of the present disclosure.

FIG. 10 illustrates an example electronic device, in accordance with certain aspects of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses and techniques for implementing data reuse in an activation buffer. For example, data to be processed during one convolution window of a neural network may be common with data to be processed during another convolution window of the neural network. An activation buffer may be used to store the data to be processed. In some aspects of the present disclosure, the activation buffer may allow for the data stored in the activation buffer to be reorganized between convolution windows such that the same data previously stored in the activation buffer for processing during one convolution window can be reused for a subsequent convolution window.

The aspects described herein reduce memory access cost and power as compared to conventional systems that do not implement data reuse. Implementing data reuse may allow for a memory bus to be implemented with a narrow bit-width (e.g., a 32-bit bus, in some implementations), reducing power consumption of the neural network system. In other words, certain implementations allow for data to be reused (e.g., reordered) using multiplexers within an activation buffer, allowing a relatively narrower bit-width to be implemented since signal paths for different order of data inputs may not be necessary. The aspects of the present disclosure also facilitate implementing various kernel sizes and model channel counts, as described in more detail herein.

Some aspects of the present disclosure may be implemented for compute-in-memory (CIM)-based machine learning (ML) circuitry. CIM-based ML/artificial intelligence (AI) task accelerators may be used for a wide variety of tasks, including image and audio processing. Further, CIM may be based on various types of memory architecture, such as dynamic random-access memory (DRAM), static random-access memory (SRAM), magnetoresistive random-access memory (MRAM), and resistive random-access memory (ReRAM), and may be attached to various types of processing units, including central processor units (CPUs), digital signal processors (DSPs), graphical processor units (GPUs), field-programmable gate arrays (FPGAs), AI accelerators, and others. Generally, CIM may beneficially reduce the “memory wall” problem, which is where the movement of data in and out of memory consumes more power than the computation of the data. Thus, by performing the computation in memory, significant power savings may be realized. This is particularly useful for various types of electronic devices, such as lower power edge processing devices, mobile devices, and the like.

For example, a mobile device may include a memory device configured for storing data and compute-in-memory operations. The mobile device may be configured to perform an ML/AI operation based on data generated by the mobile device, such as image data generated by a camera sensor of the mobile device. A memory controller unit (MCU) of the mobile device may thus load weights from another on-board memory (e.g., flash or RAM) into a CIM array of the memory device and allocate input feature buffers and output (e.g., activation) buffers. The processing device may then commence processing of the image data by loading, for example, a layer in the input buffer and processing the layer with weights loaded into the CIM array. This processing may be repeated for each layer of the image data and the output (e.g., activations) may be stored in the output buffers and then used by the mobile device for an ML/AI task, such as facial recognition.

### Brief Background on Neural Networks, Deep Neural Networks, and Deep Learning

Neural networks are organized into layers of interconnected nodes. Generally, a node (or neuron) is where computation happens. For example, a node may combine input data with a set of weights (or coefficients) that either amplifies or dampens the input data. The amplification or dampening of the input signals may thus be considered an assignment of relative significances to various inputs with regard to a task the network is trying to learn. Generally, input-weight products are summed (or accumulated) and then the sum is passed through a node's activation function to determine whether and to what extent that signal should progress further through the network.

In a most basic implementation, a neural network may have an input layer, a hidden layer, and an output layer. “Deep” neural networks generally have more than one hidden layer.

Deep learning is a method of training deep neural networks. Generally, deep learning maps inputs to the network to outputs from the network and is thus sometimes referred to as a “universal approximator” because it can learn to approximate an unknown function ƒ(x)=y between any input x and any output y. In other words, deep learning finds the right ƒ to transform x into y.

More particularly, deep learning trains each layer of nodes based on a distinct set of features, which is the output from the previous layer. Thus, with each successive layer of a deep neural network, features become more complex. Deep learning is thus powerful because it can progressively extract higher level features from input data and perform complex tasks, such as object recognition, by learning to represent inputs at successively higher levels of abstraction in each layer, thereby building up a useful feature representation of the input data.

For example, if presented with visual data, a first layer of a deep neural network may learn to recognize relatively simple features, such as edges, in the input data. In another example, if presented with auditory data, the first layer of a deep neural network may learn to recognize spectral power in specific frequencies in the input data. The second layer of the deep neural network may then learn to recognize combinations of features, such as simple shapes for visual data or combinations of sounds for auditory data, based on the output of the first layer. Higher layers may then learn to recognize complex shapes in visual data or words in auditory data. Still higher layers may learn to recognize common visual objects or spoken phrases. Thus, deep learning architectures may perform especially well when applied to problems that have a natural hierarchical structure.

### Layer Connectivity in Neural Networks

Neural networks, such as deep neural networks, may be designed with a variety of connectivity patterns between layers.

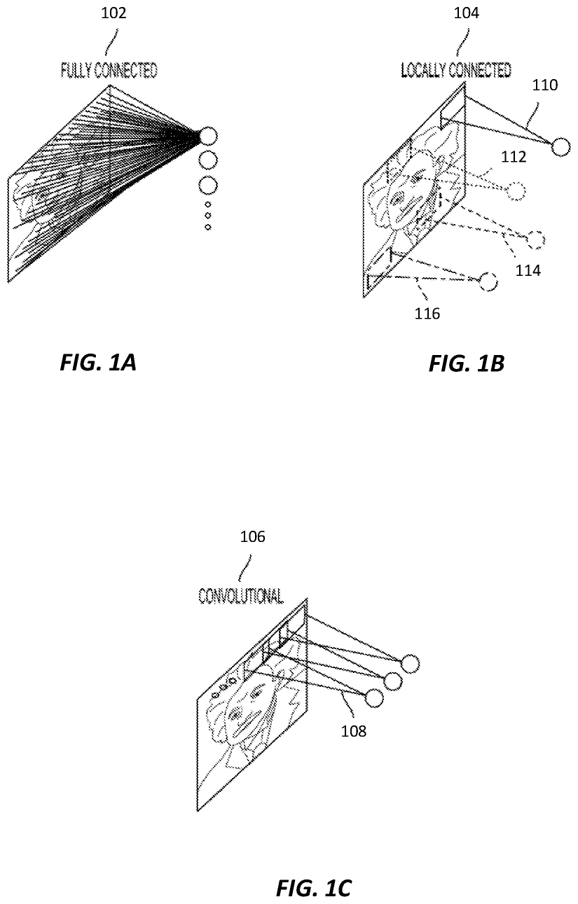

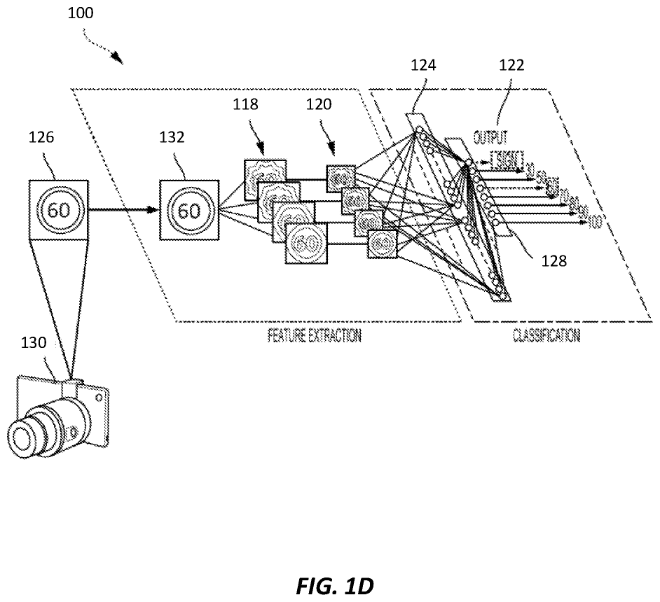

FIG. 1A illustrates an example of a fully connected neural network 102. In a fully connected neural network 102, a node in a first layer communicate its output to every node in a second layer, so that each node in the second layer will receive input from every node in the first layer.

FIG. 1B illustrates an example of a locally connected neural network 104. In a locally connected neural network 104, a node in a first layer may be connected to a limited number of nodes in the second layer. More generally, a locally connected layer of the locally connected neural network 104 may be configured so that each node in a layer will have the same or a similar connectivity pattern, but with connections strengths (or weights) that may have different values (e.g., 110, 112, 114, and 116). The locally connected connectivity pattern may give rise to spatially distinct receptive fields in a higher layer, because the higher layer nodes in a given region may receive inputs that are tuned through training to the properties of a restricted portion of the total input to the network.

One type of locally connected neural network is a convolutional neural network. FIG. 1C illustrates an example of a convolutional neural network 106. Convolutional neural network 106 may be configured such that the connection strengths associated with the inputs for each node in the second layer are shared (e.g., 108). Convolutional neural networks are well-suited to problems in which the spatial location of inputs is meaningful.

One type of convolutional neural network is a deep convolutional network (DCN). Deep convolutional networks are networks of multiple convolutional layers, which may further be configured with, for example, pooling and normalization layers.

FIG. 1D illustrates an example of a DCN 100 designed to recognize visual features in an image 126 generated by an image capturing device 130. For example, if the image capturing device 130 was a camera mounted in a vehicle, then DCN 100 may be trained with various supervised learning techniques to identify a traffic sign and even a number on the traffic sign. DCN 100 may likewise be trained for other tasks, such as identifying lane markings or identifying traffic lights. These are just some example tasks, and many others are possible.

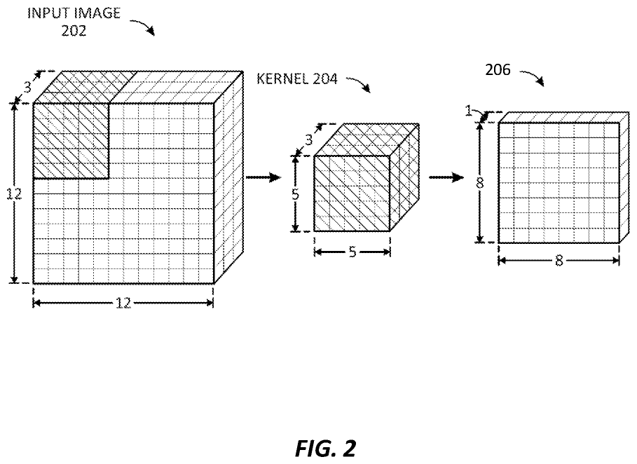

In this example, DCN 100 includes a feature extraction section and a classification section. Upon receiving the image 126, a convolutional layer 132 applies convolutional kernels (for example, as depicted and described in FIG. 2) to the image 126 to generate a first set of feature maps (or intermediate activations) 118. Generally, a “kernel” or “filter” comprises a multidimensional array of weights designed to emphasize different aspects of an input data channel. In various examples, “kernel” and “filter” may be used interchangeably to refer to sets of weights applied in a convolutional neural network.

The first set of feature maps 118 may then be subsampled by a pooling layer (e.g., a max pooling layer, not shown) to generate a second set of feature maps 120. The pooling layer may reduce the size of the first set of feature maps 118 while maintain much of the information in order to improve model performance. For example, the second set of feature maps 120 may be down-sampled to 14×14 from 28×28 by the pooling layer.

This process may be repeated through many layers. In other words, the second set of feature maps 120 may be further convolved via one or more subsequent convolutional layers (not shown) to generate one or more subsequent sets of feature maps (not shown).

In the example of FIG. 1D, the second set of feature maps 120 is provided to a fully-connected layer 124, which in turn generates an output feature vector 128. Each feature of the output feature vector 128 may include a number that corresponds to a possible feature of the image 126, such as “sign,” “60,” and “100.” In some cases, a softmax function (not shown) may convert the numbers in the output feature vector 128 to a probability. In such cases, an output 122 of the DCN 100 is a probability of the image 126 including one or more features.

A softmax function (not shown) may convert the individual elements of the output feature vector 128 into a probability in order that an output 122 of DCN 100 is one or more probabilities of the image 126 including one or more features, such as a sign with the numbers “60” on it, as in input image 126. Thus, in the present example, the probabilities in the output 122 for “sign” and “60” should be higher than the probabilities of the others of the output 122, such as “30,” “40,” “50,” “70,” “80,” “90,” and “100”.

Before training DCN 100, the output 122 produced by DCN 100 may be incorrect. Thus, an error may be calculated between the output 122 and a target output known a priori. For example, here the target output is an indication that the image 126 includes a “sign” and the number “60”. Utilizing the known, target output, the weights of DCN 100 may then be adjusted through training so that subsequent output 122 of DCN 100 achieves the target output.

To adjust the weights of DCN 100, a learning algorithm may compute a gradient vector for the weights. The gradient may indicate an amount that an error would increase or decrease if a weight were adjusted in a particular way. The weights may then be adjusted to reduce the error. This manner of adjusting the weights may be referred to as “back propagation” as it involves a “backward pass” through the layers of DCN 100.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level.

After training, DCN 100 may be presented with new images and DCN 100 may generate inferences, such as classifications, or probabilities of various features being in the new image.

### Convolution Techniques for Convolutional Neural Networks

Convolution is generally used to extract useful features from an input data set. For example, in convolutional neural networks, such as described above, convolution enables the extraction of different features using kernels and/or filters whose weights are automatically learned during training. The extracted features are then combined to make inferences.

An activation function may be applied before and/or after each layer of a convolutional neural network. Activation functions are generally mathematical functions (e.g., equations) that determine the output of a node of a neural network. Thus, the activation function determines whether it a node should pass information or not, based on whether the node's input is relevant to the model's prediction. In one example, where y=conv(x) (i.e., y=a convolution of x), both x and y may be generally considered as “activations”. However, in terms of a particular convolution operation, x may also be referred to as “pre-activations” or “input activations” as it exists before the particular convolution and y may be referred to as output activations or a feature map.

FIG. 2 depicts an example of a traditional convolution in which a 12 pixel×12 pixel×3 channel input image is convolved using a 5×5×3 convolution kernel 204 and a stride (or step size) of 1. The resulting feature map 206 is 8 pixels×8 pixels×1 channel. As seen in this example, the traditional convolution may change the dimensionality of the input data as compared to the output data (here, from 12×12 to 8×8 pixels), including the channel dimensionality (here, from 3 to 1 channel).

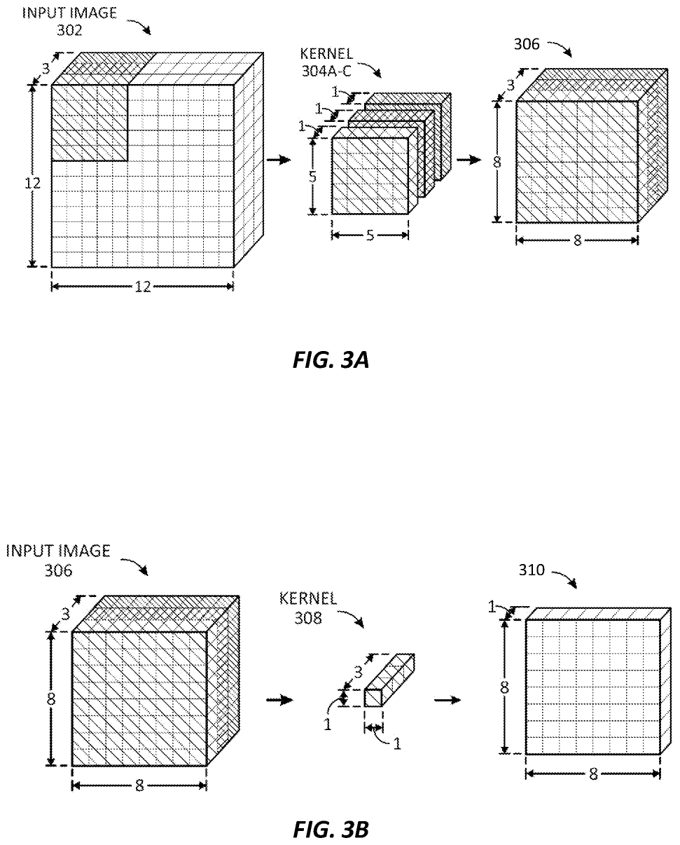

One way to reduce the computational burden (e.g., measured in floating point operations per second (FLOPs)) and the number parameters associated with a neural network comprising convolutional layers is to factorize the convolutional layers. For example, a spatial separable convolution, such as depicted in FIG. 2, may be factorized into two components: (1) a depthwise convolution, wherein each spatial channel is convolved independently by a depthwise convolution (e.g., a spatial fusion); and (2) a pointwise convolution, wherein all the spatial channels are linearly combined (e.g., a channel fusion). An examples of a depthwise separable convolution is depicted in FIGS. 3A and 3B. Generally, during spatial fusion, a network learns features from the spatial planes and during channel fusion the network learns relations between these features across channels.

In one example, a separable depthwise convolutions may be implemented using 3×3 kernels for spatial fusion, and 1×1 kernels for channel fusion. In particular, the channel fusion may use a 1×1×d kernel that iterates through every single point in an input image of depth d, wherein the depth d of the kernel generally matches the number of channels of the input image. Channel fusion via pointwise convolution is useful for dimensionality reduction for efficient computations. Applying 1×1×d kernels and adding an activation layer after the kernel may give a network added depth, which may increase its performance.

FIGS. 3A and 3B depicts an example of a depthwise separable convolution operation.

In particular, in FIG. 3A, the 12 pixel×12 pixel×3 channel input image 302 is convolved with a filter comprising three separate kernels 304A-C, each having a 5×5×1 dimensionality, to generate a feature map 306 of 8 pixels×8 pixels×3 channels, where each channel is generated by an individual kernel amongst 304A-C.

Then feature map 306 is further convolved using a pointwise convolution operation in which a kernel 308 (e.g., kernel) having dimensionality 1×1×3 to generate a feature map 310 of 8 pixels×8 pixels×1 channel. As is depicted in this example, feature map 310 has reduced dimensionality (1 channel versus 3), which allows for more efficient computations with feature map 310. In some aspects of the present disclosure, the kernels 304A-C and kernel 308 may be implemented using the same computation-in-memory (CIM) array, as described in more detail herein.

Though the result of the depthwise separable convolution in FIGS. 3A and 3B is substantially similar to the conventional convolution in FIG. 2, the number of computations is significantly reduced, and thus depthwise separable convolution offers a significant efficiency gain where a network design allows it.

Though not depicted in FIG. 3B, multiple (e.g., m) pointwise convolution kernels 308 (e.g., individual components of a filter) can be used to increase the channel dimensionality of the convolution output. So, for example, m=256 1×1×3 kernels 308 can be generated, which each output an 8 pixels×8 pixels×1 channel feature map (e.g., 310), and these feature maps can be stacked to get a resulting feature map of 8 pixels×8 pixels×256 channels. The resulting increase in channel dimensionality provides more parameters for training, which may improve a convolutional neural network's ability to identify features (e.g., in input image 302).

### Example of Convolution Processing in Memory

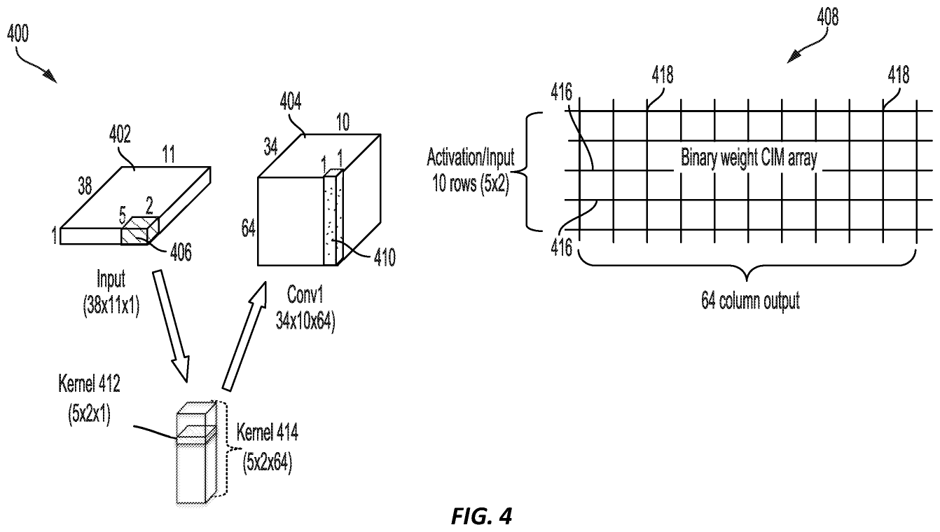

FIG. 4 depicts an exemplary convolutional layer architecture 400 implemented by a compute-in-memory (CIM) array 408. The convolutional layer architecture 400 may be a part of a convolutional neural network (e.g., as described above with respect to FIG. 1D) and designed to process multidimensional data, such as tensor data.

In the depicted example, input 402 to the convolutional layer architecture 400 has dimensions of 38 (height)×11 (width)×1 (depth). The output 404 of the convolutional layer has dimensions 34×10×64, which includes 64 output channels corresponding to the 64 kernels of filter tensor 414 applied as part of the convolution process. Further in this example, each kernel (e.g., exemplary kernel 412) of the 64 kernels of filter tensor 414 has dimensions of 5×2×1 (all together, the kernels of filter tensor 414 are equivalent to one 5×2×64 filter).

During the convolution process, each 5×2×1 kernel is convolved with the input 402 to generate one 34×10×1 layer of output 404. During the convolution, the 640 weights of filter tensor 414 (5×2×64) may be stored in the compute-in-memory (CIM) array 408, which in this example includes a column for each kernel (i.e., 64 columns). Then activations of each of the 5×2 receptive fields (e.g., receptive field input 406) are input to the CIM array 408 using the word lines, e.g., 416, and multiplied by the corresponding weights to produce a 1×1×64 output tensor (e.g., an output tensor 410). Output tensors 404 represent an accumulation of the 1×1×64 individual output tensors for all of the receptive fields (e.g., the receptive field input 406) of the input 402. For simplicity, the CIM array 408 of FIG. 4 only shows a few illustrative lines for the input and the output of the CIM array 408.

In the depicted example, CIM array 408 includes wordlines 416 through which the CIM array 408 receives the receptive fields (e.g., receptive field input 406), as well as bitlines 418 (corresponding to the columns of the CIM array 408). Though not depicted, CIM array 408 may also include precharge wordlines (PCWL) and read word lines RWL.

In this example, wordlines 416 are used for initial weight definition. However, once the initial weight definition occurs, the activation input activates a specially designed line in a CIM bitcell to perform a MAC operation. Thus, each intersection of a bitline 418 and a wordline 416 represents a filter weight value, which is multiplied by the input activation on the wordline 416 to generate a product. The individual products along each bitline 418 are then summed to generate corresponding output values of the output tensor 410. The summed value may be charge, current, or voltage. In this example, the dimensions of the output tensor 404, after processing the entire input 402 of the convolutional layer, are 34×10×64, though only 64 filter outputs are generated at a time by the CIM array 408. Thus, the processing of the entire input 402 may be completed in 34×10 or 340 cycles.

### Data Reuse Architecture Using a Multiplexer on Each Row of an Activation Buffer

Multiply and accumulate (MAC) computations are a frequent operation in machine learning processing, including for processing of deep neural networks (DNNs). Many multiplication and accumulations may be performed in the computation of each layer's output when processing a deep neural network model. As hardware MAC engine size increases, the memory bandwidth necessary to transfer input activation data from a host processing system memory, such as a static random access memory (SRAM), to the MAC engine becomes a significant efficiency consideration.

Compute-in-memory (CIM) may support a massively parallel MAC engine. For example, a 1024×256 CIM array may perform over 256,000 1-bit MAC operations in parallel, making the memory bandwidth problem particularly relevant to CIM. Certain aspects of the present disclosure are directed to activation buffer architectures that facilitate reuse of stored data in the activation buffer across machine learning operations, such as across convolution windows, in order to beneficially reduce the power consumption of processing a machine learning model.

With no data reuse, 1K bytes of input activation data per CIM array (1024×256 CIM array) and per MAC array computation may be required, limiting the performance of a machine learning model. Certain aspects of the present disclosure provide techniques for data-reuse in machine learning model MAC computations, such as for a deep neural network model, by reorganizing input data based on recurrent operations in the model processing. For example, data may be reused when a convolution window is strided in a way that previous data may be reused, which is frequent with small stride settings. Thus, for example, a MAC operation may be performed on a neural network within a convolution window. For a subsequent convolution window, a part of the input data may be common with the previous convolution window, but only multiplied with different weights. Reorganization of data in activation buffer allows for preloaded data to be reused across convolution windows, thus improving processing efficiency, reducing necessary memory bandwidth, saving processing time and processing power, and the like.

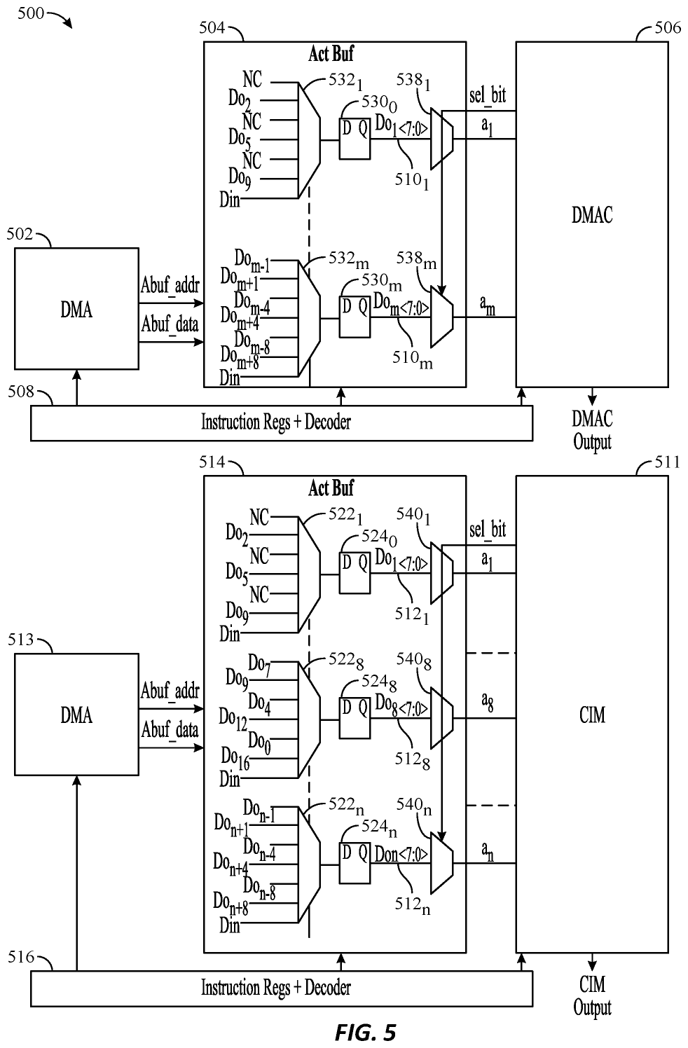

FIG. 5 illustrates aspects of a processing system 500 having circuitry for data reuse, in accordance with certain aspects of the present disclosure. As illustrated, the processing system 500 may include a direct memory access (DMA) circuit 502 to control an activation buffer 504 (e.g., via activation buffer address (Abuf_addr) and activation buffer data (Abuf_data)) for providing data inputs to a digital multiply and accumulate (DMAC) circuit 506. For example, the activation buffer 504 may store (buffer) data to be input to the DMAC circuit 506 (also referred to as computation circuitry). That is, the activation buffer 504 may include a flip-flop 530₁ to 530ₘ (e.g., D flip-flops) for each of rows a₁ to aₘ (also referred to as input rows for computation circuitry), which may be used to store the data to be input to the DMAC circuit 506 on a respective row. As illustrated, the neural network system may also include instructions registers and decoder circuitry 508 for the DMA 502, activation buffer 504 and DMAC circuit 506.

As shown, while the processing system 500 includes both a DMAC circuit and CIM circuit to facilitate understanding for both DMAC and CIM implementations, the aspects described herein may be applied to processing systems with either a DMAC circuit or a CIM circuit. A similar architecture may be used for a CIM circuit 511, in some aspects. For example, the processing system 500 may include a DMA circuit 513 to control an activation buffer 514 for providing data inputs to a CIM circuit 511 (also referred to as computation circuitry). The activation buffer 514 may store (buffer) data to be input to the CIM circuit 511. That is, the activation buffer 514 may include a flip-flop 524₁ to 524ₙ (e.g., D flip-flops) on each of rows a₀ to aₙ that may be used to store the data to be input to the CIM circuit 511, n being a positive integer (e.g., 1023). The neural network system may also include instructions registers and decoder circuitry 516 for the DMA circuit 513, activation buffer 514, and CIM circuit 511.

Each of the activation buffers 504, 514 may be implemented to facilitate data reuse by allowing reorganization of data after a MAC operation is performed as part of processing a machine learning model, such as for a convolution window of a convolutional neural network model. For example, the activation buffer 504 may allow data outputs 510₁ to 510ₘ (Do₁ to Doₘ) (collectively referred to as data outputs 510) to be reorganized. Similarly, the activation buffer 514 may allow data outputs 5121 to 512n (Do₁ to Doₙ) (collectively referred to as data outputs 512) to be reorganized. Each of the data outputs 510, 512 may include eight bit-lines for storing a byte of data.

Each of the activation buffers 504, 514 may include multiplexers to facilitate the data reuse described herein. For example, the activation buffer 504 may include multiplexers 532₁ to 532ₘ, and activation buffer 514 may include multiplexers 522₁ to 522ₙ, where n and m are integers greater than 1. To facilitate data reuse, the inputs of each multiplexer of an activation buffer may be coupled to an output of another multiplexer of the activation buffer (e.g., an output of a flip-flop coupled to an output of another multiplexer). For example, the activation buffer 514 may include multiplexers 522₁ to 522ₙ (collectively referred to as multiplexers 522) having outputs coupled to respective flip-flops 524₁ to 524ₙ. As illustrated, each input of the multiplexers 522 may be coupled to one of data outputs 512, allowing reorganization of the data by controlling the multiplexers 522. For example, as illustrated, the inputs of multiplexer 522ₙ may be coupled to data outputs Doₙ₋₁ and Doₙ₊₁, Doₙ₋₄, Doₙ₊₄, Doₙ₋₈, Doₙ₊₈, allowing the shifting of data outputs by 1, 4, and 8 rows. For instance, the inputs of the multiplexer 522o may be coupled to data outputs 5122, 5125, 5129 (Do₂, Do₅, Do₉), the inputs of the multiplexer 5228 may be coupled to data outputs 512₇, 512₉, 512₄, 512₁₂, 512₀, 512₁₆ (Do₇, Do₉, Do₄, Do₁₂, Do₀, Do₁₆), and so on.

Some inputs (labeled no connect (NC)) of the multiplexer 522₁ may not be connected to any data outputs as the multiplexer 522₁ is the first multiplexer (e.g., multiplexer for the top or initial row a₀) of the multiplexers 522. The inputs labeled NC may be grounded. Moreover, if row an is the last row of the activation buffer 514 (e.g., if the activation buffer has 1024 rows, and n is equal to 1024), then data outputs Doₙ₊₁, Doₙ₊₄, Doₙ₊₈ may be NC. Similarly, if row aₘ is the last row of the activation buffer 504 (e.g., if the activation buffer 504 has 9 rows, and m is equal to 9), then some inputs of the multiplexer 532ₘ may be NC. An input (labeled Din) of each of the multiplexers 532, 522 may configured for reception of new data to be stored in the activation buffer.

In some aspects, each bit of the byte of data stored at each data output may be processed by the DMAC circuit or the CIM circuit separately. For instance, as illustrated, the activation buffers 504 may include multiplexers 538₁ to 538ₘ configured to select, based on a selection signal (sel_bit), each bit of the byte of data stored on a respective one of data outputs 510 to be input to the DMAC circuit 506 for processing. Similarly, the activation buffers 514 may include multiplexers 540₁ to 540ₙ (collectively referred to as multiplexers 540) configured to select, based on a selection signal (sel_bit), each bit of the byte of data stored on a respective one of data outputs 512 to be input to the CIM circuit 511 for processing.

Reorganizing the data signals at the data outputs to implement data reuse may involve the data signals at the data outputs 510, 512 being shifted (e.g. shifted by 1, 2, 4, 8, or 16 (or more) rows), as described. For instance, the digital signal at the data output 5121 during a first convolution window may be provided to and stored at data output 512₈ during a subsequent convolution window. In other words, data may be organized as a single log-step shift-register where row-data can be shifted up or down in a single cycle by a quantity of rows that follow a log-step function (e.g., a logarithmic function).

### Example Signal Processing Flow for Data Reuse

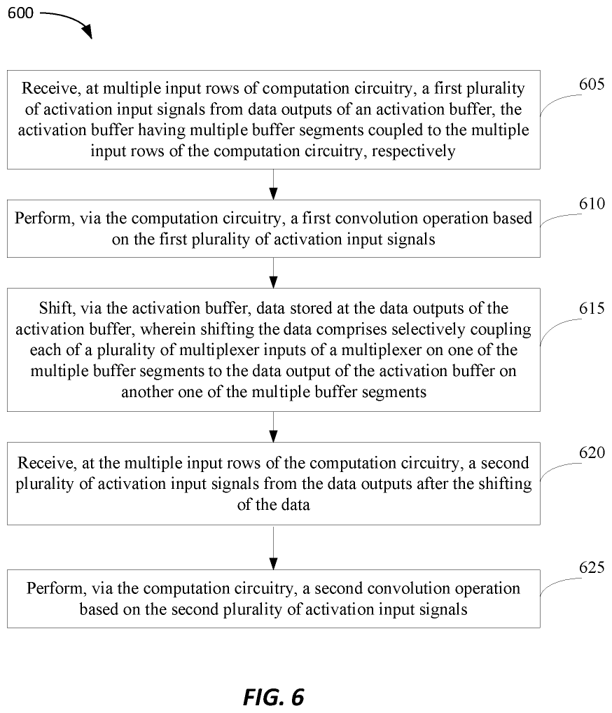

FIG. 6 is a flow diagram illustrating example operations 600 for signal processing in a machine learning model, such as a deep neural network model, in accordance with certain aspects of the present disclosure. The operations 600 may be performed by a processing system, such as the processing system 500 as described with respect to FIG. 5.

The operations 600 begin at block 605 with a processing system receiving, at multiple input rows (e.g., rows a₁ to aₙ of FIG. 5) of computation circuitry, a first plurality of activation input signals from data outputs (e.g., data outputs 512 of FIG. 5) of an activation buffer (e.g., activation buffer 514 of FIG. 5). The activation buffer may include multiple buffer segments coupled to the multiple input rows of the computation circuitry, respectively.

At block 610, the processing system may perform, via the computation circuitry, a first convolution operation based on the first plurality of activation input signals.

At block 615, the processing system may shift, via the activation buffer, data stored at the data outputs of the activation buffer. For example, shifting the data may include selectively coupling each of a plurality of multiplexer inputs of a multiplexer (e.g., each of multiplexers 522 of FIG. 5) on one of the multiple buffer segments to the data output of the activation buffer on another one of the multiple buffer segments.

At block 620, the processing system may receive, at the multiple input rows of the computation circuitry, a second plurality of activation input signals from the data outputs after the shifting of the data.

At block 625, the processing system may perform, via the computation circuitry, a second convolution operation based on the second plurality of activation input signals.

In some aspects, the one of the multiple buffer segments and the other one of the multiple buffer segments may be separated by a quantity of buffer segments. The quantity of buffer segments may be in accordance with a log-step function, as described herein.

In some aspects, the selectively coupling, at block 615, may include coupling a first multiplexer input (e.g., input of multiplexer 5228 coupled to Do₇ (e.g., data output 512₇)) of the plurality of multiplexer inputs on a first buffer segment (e.g., row as of FIG. 5) of the multiple buffer segments to the data output (e.g., data output Do₇ of FIG. 5) of the activation buffer on a second buffer segment (e.g., row a₇ of FIG. 5) of the multiple buffer segments, and coupling a second multiplexer input (e.g., input of multiplexer 522₈ coupled to Dog (e.g., data output 512₉)) of the plurality of multiplexer inputs on the first buffer segment to the data output of the activation buffer on a third buffer segment (e.g., row as of FIG. 5) of the multiple buffer segments. In some aspects, the first buffer segment and the second buffer segment are separated by a first quantity of buffer segments towards an initial buffer segment of the multiple buffer segments, and the first buffer segment and the third buffer segment are separated by the same first quantity of buffer segments towards a final buffer segment of the multiple buffer segments. The first quantity may follow a log-step function. For example, the first quantity may be 1, 2, 4, 8, 16, etc.

### Data Reuse Architecture Using a Multiplexer for Rows of an Activation Buffer

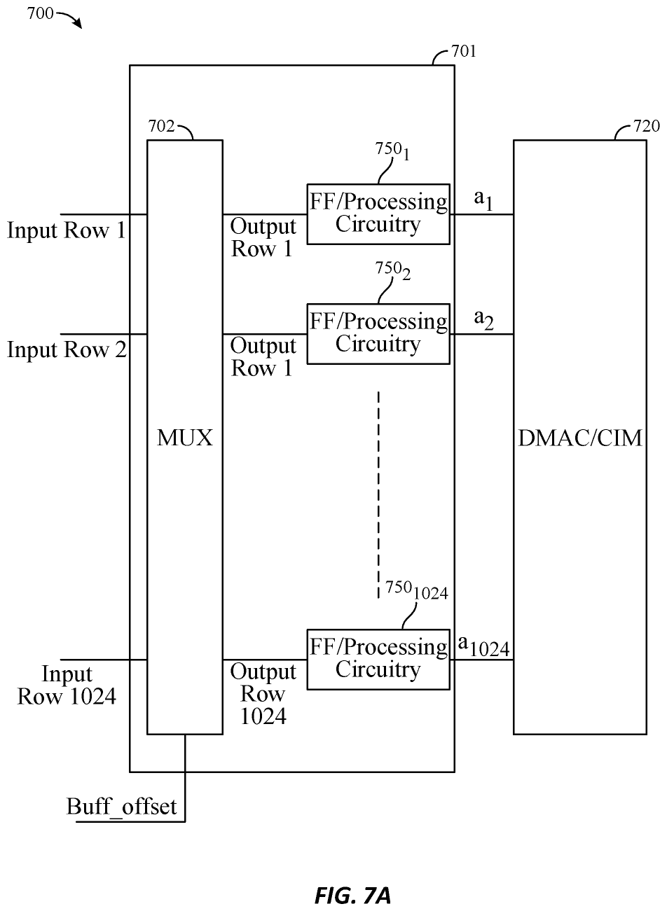

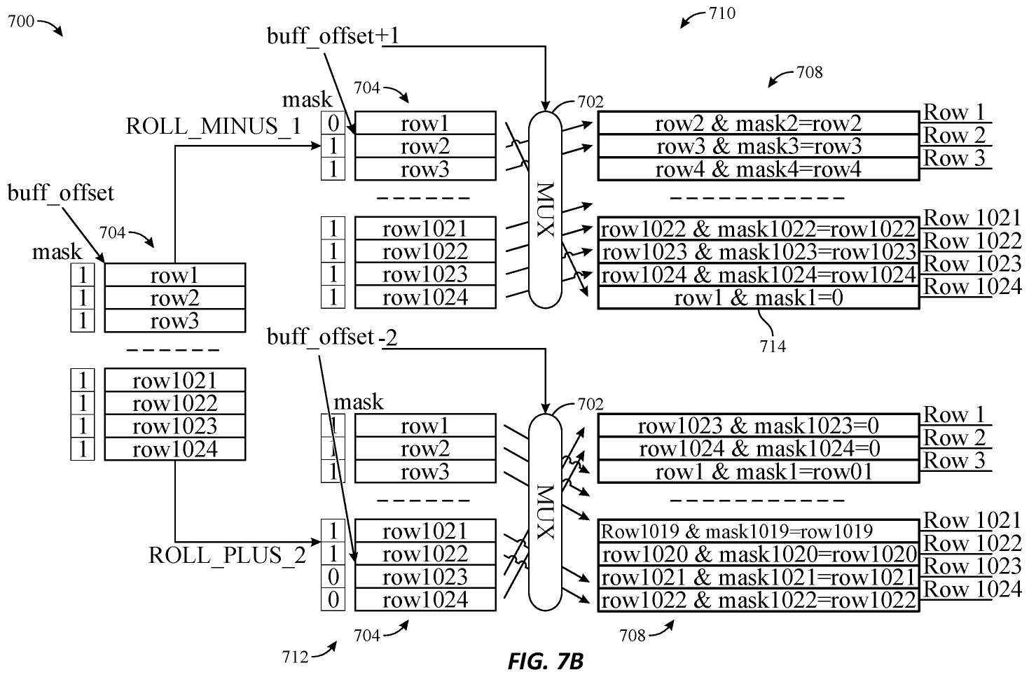

Certain aspects of the present disclosure provide a data reuse architecture implemented using a multiplexer circuit for shifting up or down data between rows of an activation buffer. A buffer offset indicator may be stored to track a quantity of data shifts that are currently active by the multiplexer, as described in more detail with respect to FIGS. 7A and 7B.

FIGS. 7A and 7B illustrate a processing system 700 having an activation buffer 701 configured for performing shifts of data between data rows using a multiplexer array 702, in accordance with certain aspects of the present disclosure. As illustrated in FIG. 7A, the activation buffer 701 may include multiple buffer rows (e.g., buffer rows 0-1023, also referred to as “buffer segments”). Each of the buffer rows (e.g., buffer segments) of the activation buffer 701 may include a row at the input side of the multiplexer array 702 referred to herein as an input row or an input node, and include a row at the output side of the multiplexer array 702 referred to herein as an output row or an output node, as shown.

The multiplexer array 702 may selectively couple each of the input rows 1-1024 to one of the output rows 1-1024 based on a buffer offset (buf_offset) indicator. For instance, the multiplexer array 702 may couple inputs rows 1-1023 to input rows 2-1024, respectively, to effectively implement a shift up of one row. As illustrated, each row may include storage and processing circuitry 750₁ to 750₁₀₂₄ (collectively referred to as storage and processing circuitry 750) for providing inputs to the computation circuitry 720 (e.g., CIM or DMAC circuitry). For example, each of the storage and processing circuitry 750 may include a flip-flop (e.g., corresponding to flip-flops 524), as well as a multiplexer (e.g., corresponding to multiplexers 540).

The multiplexer array 702 may be configured to implement various configurations, as described in more detail with respect to FIG. 7B. For example, in configuration 710, the signals at the input rows 704 (e.g., input rows 1-1024 shown in FIG. 7A) may be shifted down by 1 row. In other words, the signal at row 2 of the input rows 704 (labeled input row 2) may be electrically coupled to row 1 of the output rows 708 (labeled output row 1). In other words, output row 1 may include the signal of input row 2, as illustrated. Thus, for configuration 710, the buffer offset indicator may have a value of +1, indicating that the data stored in the activation buffers in input rows 704 are offset by positive 1 row from the data stored at the output rows 708.

In configuration 712, as depicted in FIG. 7B, the data at the input rows 704 may be shifted up by 2 rows. Thus, for configuration 712, the buffer offset indicator may have a value of negative 2, indicating that the stored values in the activation buffers in input rows 704 are offset by negative 2 rows from the data stored at the output rows 708.

In some aspects, a mask bit may be stored for each of the input rows indicating whether data stored at an output row of the activation buffer is to be zero due to data shift. In other words, for configuration 710, if there is a single shift up of rows, the topmost row (row1) of the input rows 704 may coupled to the bottom-most row (e.g., row 1024) of the output rows 708, as illustrated. Moreover, since input row 1 is the initial row (topmost row), the mask bit for input row 1 may be set to 0, indicating that the data of input row 1 is to be zero. In other words, output row 1024 may be coupled to input row 1 with a mask bit set to 0, indicating that data on output row 1024 is to be 0, as shown by block 714. The mask bit tracks whether any rows have been shifted across a top row threshold or bottom row threshold, resulting in a zero value to be set in those rows.

For example, if the initial buffer row (row 1) is shifted downwards after one convolution window, then shifted upwards after a subsequent convolution window, the data in row 1 should have a data value of zero as tracked by the corresponding mask bit. Similarly, if the final buffer row (row 1024) is shifted once upwards, then shifted once downwards, the data in the final buffer row (row 1024) should have a data value of zero as tracked by the corresponding mask bit. Therefore, the mask bit tracks whether a particular buffer row (e.g., row 1) has been shifted across a row threshold and whether the data value should have a value zero due to the shift across the row threshold.

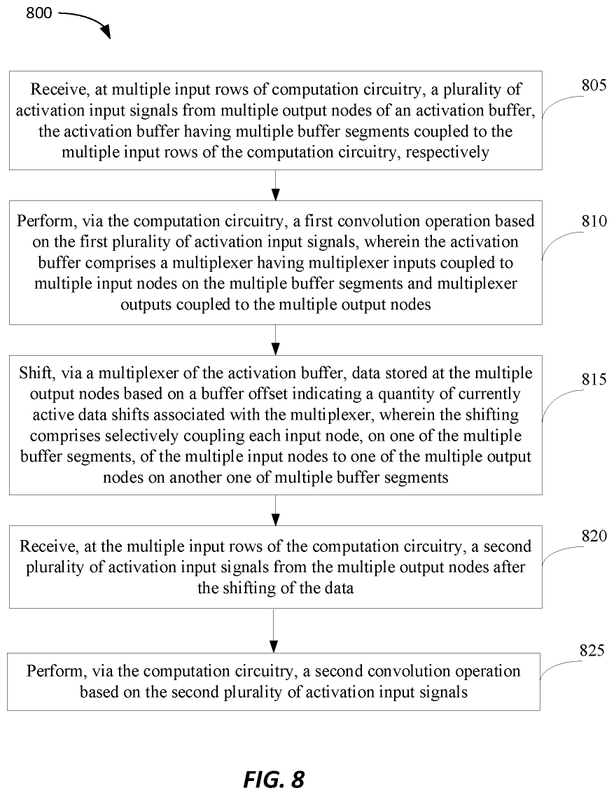

FIG. 8 is a flow diagram illustrating example operations 800 for signal processing in a machine learning model, such as a deep neural network model, in accordance with certain aspects of the present disclosure. The operations 800 may be performed by a processing system, such as the processing system 700 described with respect to FIGS. 7A and 7B.

The operations 800 begin at block 805 with processing system receiving, at multiple input rows (e.g., at rows a₁-a₁₀₂₄, shown in FIG. 7A) of computation circuitry (e.g., computation circuitry 720), a plurality of activation input signals from multiple output nodes (e.g., output rows 708) of an activation buffer (e.g., activation buffer 701). The activation buffer may include multiple buffer segments coupled to the multiple input rows of the computation circuitry, respectively.

At block 810, the processing system may perform, via the computation circuitry, a first convolution operation based on the first plurality of activation input signals. In some aspects, the activation buffer may include a multiplexer (e.g., multiplexer array 702) having multiplexer inputs coupled to multiple input nodes (e.g., at input rows 704) on the multiple buffer segments and multiplexer outputs coupled to the multiple output nodes.

At block 815, the processing system may shift, via the multiplexer of the activation buffer, data stored at the multiple output nodes based on a buffer offset (e.g., buf_offset indicator) indicating a quantity of currently active data shifts associated with the multiplexer. The shifting at block 815 may include selectively coupling each input node (e.g., input row 1 of FIG. 7A), on one of the multiple buffer segments, of the multiple input nodes to one of the multiple output nodes (e.g., output row 0 of FIG. 7A) on another one of multiple buffer segments.

At block 820, the processing system may receive, at the multiple input rows of the computation circuitry, a second plurality of activation input signals from the multiple output nodes after the shifting of the data.

At block 825, the neural network system may perform, via the computation circuitry, a second convolution operation based on the second plurality of activation input signals.

In some aspects, the neural network system may also store a mask bit for each buffer segment of the multiple buffer segments. The mask bit may indicate whether a data value associated with the buffer segment is to be zero after the data shift.

In some aspects, the shifting, at block 815, may include receiving, via the multiplexer, an indication of a quantity of data shifts to be applied between the multiple buffer segments, and selectively coupling each of the multiple input nodes (e.g., input row 2 of FIG. 7A) to one of the multiple output nodes (e.g., output row 1 of FIG. 7A) to apply the quantity of data shifts based on the buffer offset indicating the quantity of currently active data shifts. Example Data Reorganization Facilitating Data Reuse

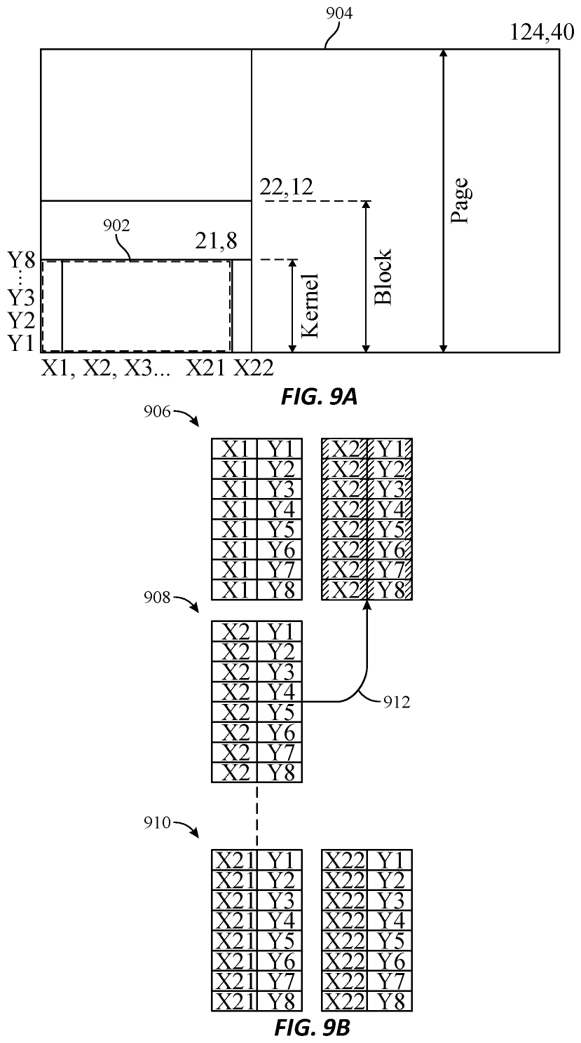

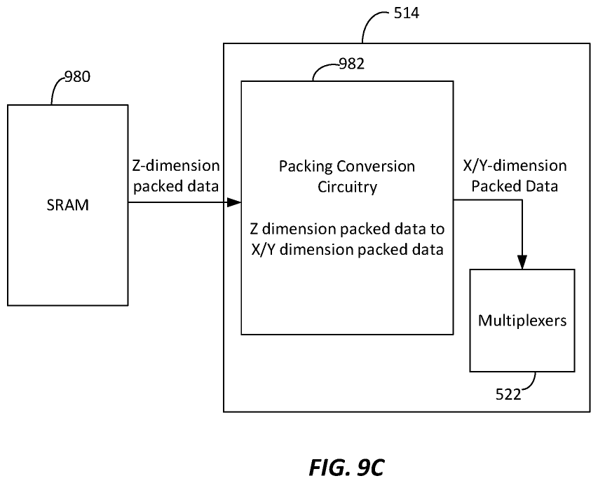

As described herein, a MAC operation may be performed as part of processing a machine learning model, such as a neural network model. In one example, a first convolution window may be processed followed by processing a second, subsequent convolution window. The input data (e.g., an input data patch) processed for the subsequent convolution window may significantly overlap with the data processed for the previous convolution window, such as where a small stride is used between convolution windows. The commonality between the data across convolution windows in this example allows for data reuse within the activation buffer. This commonality of data across convolution windows may be facilitated by organizing input data in a manner described with respect to FIGS. 9A and 9B.

FIGS. 9A and 9B illustrate example input data associated with x and y dimensions of a model input, in accordance with certain aspects of the present disclosure. As illustrated in FIG. 9A, the size of the input frame 904 may be 124 in the x-dimension and 40 in the y-dimension. Moreover, although not shown in FIG. 9A, the input frame size may have three channels for the z-dimension.

The size of a convolution kernel (e.g., kernel 902) may be 21 in the x-dimension and 9 in the y-dimension. Thus, a MAC operation may be performed on a kernel having a size of 21×8. For performing the MAC operation, the kernel may be stored in the activation buffer (e.g., activation buffer 504, 514 of FIG. 5, or activation buffer 701 of FIG. 7A). In some aspects, the data may be stored in the y-direction first. For example, the first set of data 906 may include data for Y1 to Y8 for X1, and the second set of data 908 may include data for Y1 to Y8 for X2, and so on until X21 (e.g., until the last set of data 910 having data for Y1 to Y8 for X21). This process may be performed for each of the three channels. Therefore, a total of 21×8×3 bytes of data may be stored in the activation buffer for the kernel 902.

After the data is stored in the activation buffer, and the MAC operation is performed, the convolution window may slide to the right within the input frame 904 by a single unit in the x-dimension if the stride is equal to 1. The stride generally refers to the number of dimension units the convolution window may slide after each convolution operation. Therefore, the X1 dimension data (e.g., first set of data 906) may be discarded. The X2 to X21 dimension data (e.g., second set of data 908 to the last set of data 910) may be shifted up by eight rows.

For example, the second set of data 908 may be shifted up by eight rows, as shown by arrow 912, such that the second set of data 908 is now being multiplied by the weights associated with rows 1-8 (e.g., as stored in CIM cells on rows 1-8). In this manner, x-dimension and y-dimension data may be packed together in the activation buffer, while z-dimension data may be packed together in another memory, such as a static SRAM.

FIG. 9C illustrating an activation buffer having packing conversion circuitry 982, in accordance with certain aspects of the present disclosure. In some implementations, convolution inputs may be stored in memory (e.g., SRAM 980) using Z-dimension packing. In other words, Z-dimension data may be stored together in the SRAM 980.

Packing x-dimension and y-dimension data in the activation buffer facilitates data to be reused across different convolution windows, as described. As illustrated, an activation buffer may include packing conversion circuitry that converts z-dimension packed data to x/y-dimension packed data. For instance, the activation buffer 514 may include the packing conversion circuitry 982 that unpacks z-dimension data stored in SRAM 980, and subsequently packs the data such that x/y dimension data are together, as described with repsect to FIG. 9A. The x/y dimension packed data may be provided to the Din inputs of the multiplexers (e.g., multiplexers 522) to be stored in the activation buffer, as described with respect to FIG. 5.

Z-dimension packing in the SRAM enables efficient contiguous reads, while x/y-dimension packing in the activation buffer enables arbitrary kernel/stride size support along with the log-step shift. In other words, for the example kernel size described with respect to FIG. 9A, the stride size of 1 may be implemented by shifting data by eight rows (e.g., due to 8 Y-dimension units of the kernel) between convolution windows, or a stride size of 2 may be implemented by shifting data by 16 rows, as enabled by the example activation buffers described herein. Moreover, the example activation buffers described herein allow for data to be stored for various kernel sizes while still allowing for data reuse to occur. An efficient DMA instruction set enables data reorganization when moving the instructions set from memory (e.g., SRAM) to the activation buffer.

### Example Processing Systems for Performing Phase Selective Convolution

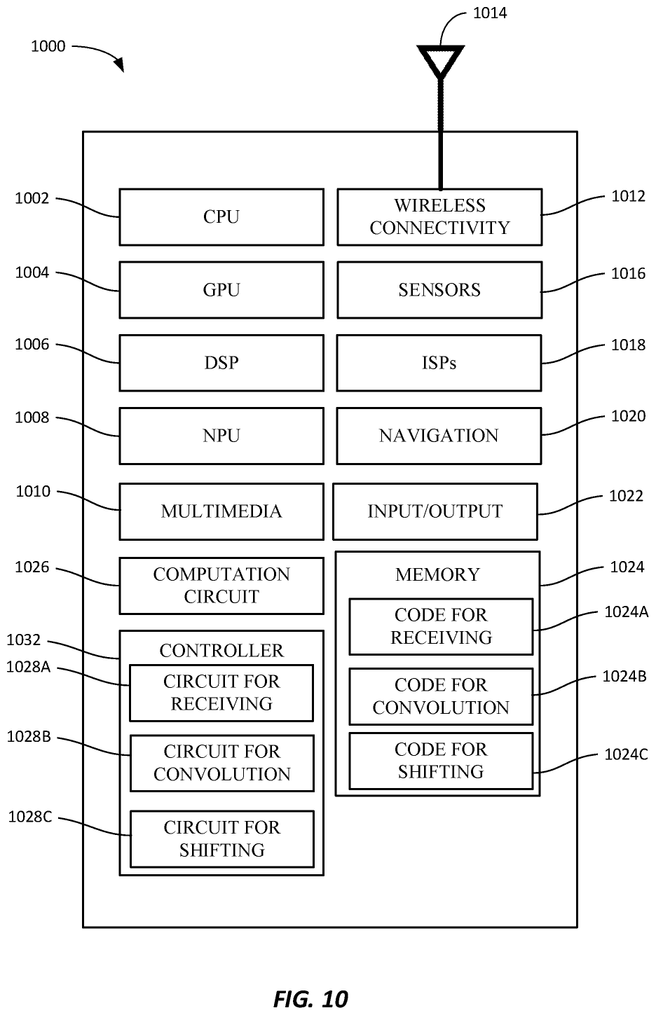

FIG. 10 illustrates an example electronic device 1000. Electronic device 1000 may be configured to perform the methods described herein, including operations 600, 800 described with respect to FIGS. 6 and 8.

Electronic device 1000 includes a central processing unit (CPU) 1002, which in some aspects may be a multi-core CPU. Instructions executed at the CPU 1002 may be loaded, for example, from a program memory associated with the CPU 1002 or may be loaded from a memory 1024.

Electronic device 1000 also includes additional processing blocks tailored to specific functions, such as a graphics processing unit (GPU) 1004, a digital signal processor (DSP) 1006, a neural processing unit (NPU) 1008, a multimedia processing block 1010, a multimedia processing block 1010, and a wireless connectivity processing block 1012. In one implementation, NPU 1008 is implemented in one or more of CPU 1002, GPU 1004, and/or DSP 1006.

In some embodiments, wireless connectivity processing block 1012 may include components, for example, for third generation (3G) connectivity, fourth generation (4G) connectivity (e.g., 4G LTE), fifth generation connectivity (e.g., 5G or NR), Wi-Fi connectivity, Bluetooth connectivity, and wireless data transmission standards. Wireless connectivity processing block 1012 is further connected to one or more antennas 1014 to facilitate wireless communication.

Electronic device 1000 may also include one or more sensor processors 1016 associated with any manner of sensor, one or more image signal processors (ISPs) 1018 associated with any manner of image sensor, and/or a navigation processor 1020, which may include satellite-based positioning system components (e.g., GPS or GLONASS) as well as inertial positioning system components.

Electronic device 1000 may also include one or more input and/or output devices 1022, such as screens, touch-sensitive surfaces (including touch-sensitive displays), physical buttons, speakers, microphones, and the like. In some aspects, one or more of the processors of electronic device 1000 may be based on an ARM instruction set.

Electronic device 1000 also includes memory 1024, which is representative of one or more static and/or dynamic memories, such as a dynamic random access memory, a flash-based static memory, and the like. In this example, memory 1024 includes computer-executable components, which may be executed by one or more of the aforementioned processors of electronic device 1000 or a controller 1032. For example, the electronic device 1000 may include a computation circuit 1026, as described herein. The computation circuit 1026 may be controlled via the controller 1032. For instance, in some aspects, memory 1024 may include code 1024A for receiving (e.g., receiving activation input signals), code 1024B for performing convolution, and code 1024C for shifting (e.g., shifting data stored at data outputs of an activation buffer). As illustrated, the controller 1032 may include a circuit 1028A for receiving (e.g., receiving activation input signals), circuit 1028B for performing convolution, and code 1028C for shifting (e.g., shifting data stored at data outputs of an activation buffer). The depicted components, and others not depicted, may be configured to perform various aspects of the methods described herein.

In some aspects, such as where electronic device 1000 is a server device, various aspects may be omitted from the aspects depicted in FIGS. 6 and 8, such as one or more of multimedia processing block 1010, wireless connectivity component 1012, antenna 1014, sensor processors 1016, ISPs 1018, or navigation 1020.

### Example Clauses

Clause 1. An apparatus, comprising: computation circuitry configured to perform a convolution operation, the computation circuitry having multiple input rows; and an activation buffer having multiple buffer segments coupled to the multiple input rows of the computation circuitry, respectively, wherein: each of the multiple buffer segments comprises a first multiplexer having a plurality of multiplexer inputs; and each of the plurality of multiplexer inputs of one of the first multiplexers on one of the multiple buffer segments is coupled to a data output of the activation buffer on another one of the multiple buffer segments.

Clause 2. The apparatus of clause 1, wherein the one of the multiple buffer segments and the other one of the multiple buffer segments are separated by a quantity of buffer segments, the quantity of buffer segments being in accordance with a log-step function.

Clause 3. The apparatus of any one of clauses 1-2, wherein: a first multiplexer input of the plurality of multiplexer inputs on a first buffer segment of the multiple buffer segments is coupled to the data output of the activation buffer on a second buffer segment of the multiple buffer segments; a second multiplexer input of the plurality of multiplexer inputs on the first buffer segment is coupled to the data output of the activation buffer on a third buffer segment of the multiple buffer segments; the first buffer segment and the second buffer segment are separated by a first quantity of buffer segments towards an initial buffer segment of the multiple buffer segments; and the first buffer segment and the third buffer segment are separated by the same first quantity of buffer segments towards a final buffer segment of the multiple buffer segments.

Clause 4. The apparatus of clause 3, wherein: a third multiplexer input of the plurality of multiplexer inputs on the first buffer segment is coupled to the data output of the activation buffer on a fourth buffer segment of the multiple buffer segments; a fourth multiplexer input of the plurality of multiplexer inputs on the first buffer segment is coupled to the data output of the activation buffer on a fifth buffer segment of the multiple buffer segments; the first buffer segment and the fourth buffer segment are separated by a second quantity of buffer segments towards the initial buffer segment of the multiple buffer segments; and the first buffer segment and the fifth buffer segment are separated by the same second quantity of buffer segments towards the final buffer segment of the multiple buffer segments.

Clause 5. The apparatus of clause 4, wherein: the first quantity of buffer segments is in accordance with a log-step function; and the second quantity of buffer segments is in accordance with the log-step function.

Clause 6. The apparatus of any one of clauses 1-5, wherein the activation buffer comprises a flip-flop coupled between each of the data outputs of the activation buffer and an output of each of the first multiplexers.

Clause 7. The apparatus of clause 6, wherein the flip-flop comprises a D flip-flop.

Clause 8. The apparatus of any one of clauses 1-7, wherein the activation buffer further comprises a second multiplexer coupled between each of the data outputs and a respective one of the multiple input rows of the computation circuitry.

Clause 9. The apparatus of clause 8, wherein each of the data outputs is configured to store a plurality of bits, and wherein the second multiplexer is configured to selectively couple each of the plurality of bits to the respective one of the multiple input rows of the computation circuitry.

Clause 10. The apparatus of any one of clauses 1-9, wherein the computation circuitry comprises a computation in memory (CIM) circuit.

Clause 11. The apparatus of any one of clauses 1-10, wherein the computation circuitry comprises a digital multiply and accumulate (DMAC) circuit.

Clause 12. The apparatus of any one of clauses 1-11, wherein data associated with x and y dimensions of a neural network input are stored together at the data outputs of the activation buffer.

Clause 13. The apparatus of clause 12, further comprising a memory, wherein data associated with a z dimension of the neural network input are stored together in the memory, wherein the activation buffer further comprises packing conversion circuitry configured to: receive the data stored in the memory; and organize the data stored in the memory such that the data associated with the x and y dimensions of the neural network input are stored together at the data outputs of the activation buffer.

Clause 14. An apparatus for signal processing in a neural network, comprising: computation circuitry configured to perform a convolution operation, the computation circuit having multiple input rows; and an activation buffer having multiple buffer segments coupled to the multiple input rows of the computation circuitry, respectively, wherein: the activation buffer comprises a multiplexer having multiplexer inputs coupled to multiple input nodes of the multiple buffer segments and multiplexer outputs coupled to multiple output nodes of the multiple buffer segments; the multiplexer is configured to selectively couple each input node, on one of the multiple buffer segments, of the multiple input nodes to one of the multiple output nodes on another one of multiple buffer segments to perform a data shift between the multiple buffer segments; and the activation buffer is further configured to store a buffer offset indicating a quantity of currently active data shifts associated with the multiplexer.

Clause 15. The apparatus of clause 14, wherein the activation buffer is further configured store a mask bit for each buffer segment of the multiple buffer segments, wherein the mask bit indicates whether a data value associated with the buffer segment is to be zero after the data shift.

Clause 16. The apparatus of any one of clauses 14-15, wherein the multiplexer is configured to: receive an indication of a quantity of data shifts to be applied between the multiple buffer segments; and selectively couple each of the multiple input nodes to one of the multiple output nodes to apply the quantity of data shifts based on the buffer offset indicating the quantity of currently active data shifts.

Clause 17. The apparatus of any one of clauses 14-16, wherein the computation circuitry comprises a computation in memory (CIM) circuit.

Clause 18. The apparatus of any one of clauses 14-17, wherein the computation circuitry comprises a digital multiply and accumulate (DMAC) circuit.

Clause 19. The apparatus of any one of clauses 14-18, wherein data associated with x and y dimensions of a neural network input are stored together at the multiple output nodes of the activation buffer.

Clause 20. The apparatus of clause 19, further comprising a memory, wherein data associated with a z dimension of the neural network input are stored together in the memory, wherein the activation buffer further comprises packing conversion circuitry configured to: receive the data stored in the memory; and organize the data stored in the memory such that the data associated with the x and y dimensions of the neural network input are stored together at the data outputs of the activation buffer.

Clause 21. A method for signal processing in a neural network, comprising: receiving, at multiple input rows of computation circuitry, a first plurality of activation input signals from data outputs of an activation buffer, the activation buffer having multiple buffer segments coupled to the multiple input rows of the computation circuitry, respectively; performing, via the computation circuitry, a first convolution operation based on the first plurality of activation input signals; shifting, via the activation buffer, data stored at the data outputs of the activation buffer, wherein shifting the data comprises selectively coupling each of a plurality of multiplexer inputs of a multiplexer on one of the multiple buffer segments to the data output of the activation buffer on another one of the multiple buffer segments; receiving, at the multiple input rows of the computation circuitry, a second plurality of activation input signals from the data outputs after the shifting of the data; and performing, via the computation circuitry, a second convolution operation based on the second plurality of activation input signals.

Clause 22. The method of clause 21, wherein the one of the multiple buffer segments and the other one of the multiple buffer segments are separated by a quantity of buffer segments, the quantity of buffer segments being in accordance with a log-step function.

Clause 23. The method of any one of clauses 21-22, wherein the selectively coupling comprises: coupling a first multiplexer input of the plurality of multiplexer inputs on a first buffer segment of the multiple buffer segments to the data output of the activation buffer on a second buffer segment of the multiple buffer segments; and coupling a second multiplexer input of the plurality of multiplexer inputs on the first buffer segment to the data output of the activation buffer on a third buffer segment of the multiple buffer segments, wherein the first buffer segment and the second buffer segment are separated by a first quantity of buffer segments towards an initial buffer segment of the multiple buffer segments, and the first buffer segment and the third buffer segment are separated by the same first quantity of buffer segments towards a final buffer segment of the multiple buffer segments.

Clause 24. The method of clause 23, wherein the selectively coupling further comprises: coupling a third multiplexer input of the plurality of multiplexer inputs on the first buffer segment to the data output of the activation buffer on a fourth buffer segment of the multiple buffer segments; and coupling a fourth multiplexer input of the plurality of multiplexer inputs on the first buffer segment to the data output of the activation buffer on a fifth buffer segment of the multiple buffer segments, wherein the first buffer segment and the fourth buffer segment are separated by a second quantity of buffer segments towards the initial buffer segment of the multiple buffer segments, and the first buffer segment and the fifth buffer segment are separated by the same second quantity of buffer segments towards the final buffer segment of the multiple buffer segments.

Clause 25. The method of clause 24, wherein: the first quantity of buffer segments is in accordance with a log-step function; and the second quantity of buffer segments is in accordance with the log-step function.

Clause 26. The method of any one of clauses 21-25, wherein the computation circuitry comprises a computation in memory (CIM) circuit.

Clause 27. The method of any one of clauses 21-26, wherein the computation circuitry comprises a digital multiply and accumulate (DMAC) circuit.

Clause 28. A method for signal processing in a neural network, comprising: receiving, at multiple input rows of computation circuitry, a first plurality of activation input signals from multiple output nodes of an activation buffer, the activation buffer having multiple buffer segments coupled to the multiple input rows of the computation circuitry, respectively; performing, via the computation circuitry, a first convolution operation based on the first plurality of activation input signals, wherein the activation buffer comprises a multiplexer having multiplexer inputs coupled to multiple input nodes on the multiple buffer segments and multiplexer outputs coupled to the multiple output nodes; shifting, via the multiplexer of the activation buffer, data stored at the multiple output nodes based on a buffer offset indicating a quantity of currently active data shifts associated with the multiplexer, wherein the shifting comprises selectively coupling each input node, on one of the multiple buffer segments, of the multiple input nodes to one of the multiple output nodes on another one of multiple buffer segments; receiving, at the multiple input rows of the computation circuitry, a second plurality of activation input signals from the multiple output nodes after the shifting of the data; and performing, via the computation circuitry, a second convolution operation based on the second plurality of activation input signals.

Clause 29. The method of clause 28, further comprising storing a mask bit for each buffer segment of the multiple buffer segments, wherein the mask bit indicates whether a data value associated with the buffer segment is to be zero after the data shift.

Clause 30. The method of any one of clauses 28-29, wherein the shifting further comprises: receiving, via the multiplexer, an indication of a quantity of data shifts to be applied between the multiple buffer segments; and selectively coupling each of the multiple input nodes to one of the multiple output nodes to apply the quantity of data shifts based on the buffer offset indicating the quantity of currently active data shifts.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus, comprising:
computation circuitry configured to perform a convolution operation, the computation circuitry having multiple input rows; and
an activation buffer having multiple buffer segments coupled to the multiple input rows of the computation circuitry, respectively, wherein:
each of the multiple buffer segments comprises a first multiplexer having a plurality of multiplexer inputs; and
each of the plurality of multiplexer inputs of one of the first multiplexers on one of the multiple buffer segments is coupled to a data output of the activation buffer on another one of the multiple buffer segments.

2. The apparatus of claim 1, wherein the one of the multiple buffer segments and the other one of the multiple buffer segments are separated by a quantity of buffer segments, the quantity of buffer segments being in accordance with a log-step function.

3. The apparatus of claim 1, wherein:
a first multiplexer input of the plurality of multiplexer inputs on a first buffer segment of the multiple buffer segments is coupled to the data output of the activation buffer on a second buffer segment of the multiple buffer segments;
a second multiplexer input of the plurality of multiplexer inputs on the first buffer segment is coupled to the data output of the activation buffer on a third buffer segment of the multiple buffer segments;
the first buffer segment and the second buffer segment are separated by a first quantity of buffer segments towards an initial buffer segment of the multiple buffer segments; and
the first buffer segment and the third buffer segment are separated by the same first quantity of buffer segments towards a final buffer segment of the multiple buffer segments.

4. The apparatus of claim 3, wherein:
a third multiplexer input of the plurality of multiplexer inputs on the first buffer segment is coupled to the data output of the activation buffer on a fourth buffer segment of the multiple buffer segments;
a fourth multiplexer input of the plurality of multiplexer inputs on the first buffer segment is coupled to the data output of the activation buffer on a fifth buffer segment of the multiple buffer segments;
the first buffer segment and the fourth buffer segment are separated by a second quantity of buffer segments towards the initial buffer segment of the multiple buffer segments; and
the first buffer segment and the fifth buffer segment are separated by the same second quantity of buffer segments towards the final buffer segment of the multiple buffer segments.

5. The apparatus of claim 4, wherein:
the first quantity of buffer segments is in accordance with a log-step function; and
the second quantity of buffer segments is in accordance with the log-step function.

6. The apparatus of claim 1, wherein the activation buffer comprises a flip-flop coupled between each of the data outputs of the activation buffer and an output of each of the first multiplexers.

7. The apparatus of claim 6, wherein the flip-flop comprises a D flip-flop.

8. The apparatus of claim 1, wherein the activation buffer further comprises a second multiplexer coupled between each of the data outputs and a respective one of the multiple input rows of the computation circuitry.

9. The apparatus of claim 8, wherein each of the data outputs is configured to store a plurality of bits, and wherein the second multiplexer is configured to selectively couple each of the plurality of bits to the respective one of the multiple input rows of the computation circuitry.

10. The apparatus of claim 1, wherein the computation circuitry comprises a computation in memory (CIM) circuit.

11. The apparatus of claim 1, wherein the computation circuitry comprises a digital multiply and accumulate (DMAC) circuit.

12. The apparatus of claim 1, wherein data associated with x and y dimensions of a neural network input are stored together at the data outputs of the activation buffer.

13. The apparatus of claim 12, further comprising a memory, wherein data associated with a z dimension of the neural network input are stored together in the memory, wherein the activation buffer further comprises packing conversion circuitry configured to:
receive the data stored in the memory; and
organize the data stored in the memory such that the data associated with the x and y dimensions of the neural network input are stored together at the data outputs of the activation buffer.

14. An apparatus for signal processing in a neural network, comprising:
computation circuitry configured to perform a convolution operation, the computation circuit having multiple input rows; and
an activation buffer having multiple buffer segments coupled to the multiple input rows of the computation circuitry, respectively, wherein:
the activation buffer comprises a multiplexer having multiplexer inputs coupled to multiple input nodes of the multiple buffer segments and multiplexer outputs coupled to multiple output nodes of the multiple buffer segments;
the multiplexer is configured to selectively couple each input node, on one of the multiple buffer segments, of the multiple input nodes to one of the multiple output nodes on another one of multiple buffer segments to perform a data shift between the multiple buffer segments; and
the activation buffer is further configured to store a buffer offset indicating a quantity of currently active data shifts associated with the multiplexer.

15. The apparatus of claim 14, wherein the activation buffer is further configured store a mask bit for each buffer segment of the multiple buffer segments, wherein the mask bit indicates whether a data value associated with the buffer segment is to be zero after the data shift.

16. The apparatus of claim 14, wherein the multiplexer is configured to:
receive an indication of a quantity of data shifts to be applied between the multiple buffer segments; and
selectively couple each of the multiple input nodes to one of the multiple output nodes to apply the quantity of data shifts based on the buffer offset indicating the quantity of currently active data shifts.

17. The apparatus of claim 14, wherein the computation circuitry comprises a computation in memory (CIM) circuit.

18. The apparatus of claim 14, wherein the computation circuitry comprises a digital multiply and accumulate (DMAC) circuit.

19. The apparatus of claim 14, wherein data associated with x and y dimensions of a neural network input are stored together at the multiple output nodes of the activation buffer.

20. The apparatus of claim 19, further comprising a memory, wherein data associated with a z dimension of the neural network input are stored together in the memory, wherein the activation buffer further comprises packing conversion circuitry configured to:
receive the data stored in the memory; and
organize the data stored in the memory such that the data associated with the x and y dimensions of the neural network input are stored together at the data outputs of the activation buffer.

21. A method for signal processing in a neural network, comprising:
receiving, at multiple input rows of computation circuitry, a first plurality of activation input signals from data outputs of an activation buffer, the activation buffer having multiple buffer segments coupled to the multiple input rows of the computation circuitry, respectively;
performing, via the computation circuitry, a first convolution operation based on the first plurality of activation input signals;
shifting, via the activation buffer, data stored at the data outputs of the activation buffer, wherein shifting the data comprises selectively coupling each of a plurality of multiplexer inputs of a multiplexer on one of the multiple buffer segments to the data output of the activation buffer on another one of the multiple buffer segments;
receiving, at the multiple input rows of the computation circuitry, a second plurality of activation input signals from the data outputs after the shifting of the data; and
performing, via the computation circuitry, a second convolution operation based on the second plurality of activation input signals.

22. The method of claim 21, wherein the one of the multiple buffer segments and the other one of the multiple buffer segments are separated by a quantity of buffer segments, the quantity of buffer segments being in accordance with a log-step function.

23. The method of claim 21, wherein the selectively coupling comprises:
coupling a first multiplexer input of the plurality of multiplexer inputs on a first buffer segment of the multiple buffer segments to the data output of the activation buffer on a second buffer segment of the multiple buffer segments; and
coupling a second multiplexer input of the plurality of multiplexer inputs on the first buffer segment to the data output of the activation buffer on a third buffer segment of the multiple buffer segments, wherein
the first buffer segment and the second buffer segment are separated by a first quantity of buffer segments towards an initial buffer segment of the multiple buffer segments, and
the first buffer segment and the third buffer segment are separated by the same first quantity of buffer segments towards a final buffer segment of the multiple buffer segments.

24. The method of claim 23, wherein the selectively coupling further comprises:
coupling a third multiplexer input of the plurality of multiplexer inputs on the first buffer segment to the data output of the activation buffer on a fourth buffer segment of the multiple buffer segments; and
coupling a fourth multiplexer input of the plurality of multiplexer inputs on the first buffer segment to the data output of the activation buffer on a fifth buffer segment of the multiple buffer segments, wherein
the first buffer segment and the fourth buffer segment are separated by a second quantity of buffer segments towards the initial buffer segment of the multiple buffer segments, and
the first buffer segment and the fifth buffer segment are separated by the same second quantity of buffer segments towards the final buffer segment of the multiple buffer segments.

25. The method of claim 24, wherein:
the first quantity of buffer segments is in accordance with a log-step function; and
the second quantity of buffer segments is in accordance with the log-step function.

26. The method of claim 21, wherein the computation circuitry comprises a computation in memory (CIM) circuit.

27. The method of claim 21, wherein the computation circuitry comprises a digital multiply and accumulate (DMAC) circuit.

28. A method for signal processing in a neural network, comprising:
receiving, at multiple input rows of computation circuitry, a first plurality of activation input signals from multiple output nodes of an activation buffer, the activation buffer having multiple buffer segments coupled to the multiple input rows of the computation circuitry, respectively;
performing, via the computation circuitry, a first convolution operation based on the first plurality of activation input signals, wherein the activation buffer comprises a multiplexer having multiplexer inputs coupled to multiple input nodes on the multiple buffer segments and multiplexer outputs coupled to the multiple output nodes;
shifting, via the multiplexer of the activation buffer, data stored at the multiple output nodes based on a buffer offset indicating a quantity of currently active data shifts associated with the multiplexer, wherein the shifting comprises selectively coupling each input node, on one of the multiple buffer segments, of the multiple input nodes to one of the multiple output nodes on another one of multiple buffer segments;
receiving, at the multiple input rows of the computation circuitry, a second plurality of activation input signals from the multiple output nodes after the shifting of the data; and
performing, via the computation circuitry, a second convolution operation based on the second plurality of activation input signals.

29. The method of claim 28, further comprising storing a mask bit for each buffer segment of the multiple buffer segments, wherein the mask bit indicates whether a data value associated with the buffer segment is to be zero after the data shift.

30. The method of claim 28, wherein the shifting further comprises:
receiving, via the multiplexer, an indication of a quantity of data shifts to be applied between the multiple buffer segments; and
selectively coupling each of the multiple input nodes to one of the multiple output nodes to apply the quantity of data shifts based on the buffer offset indicating the quantity of currently active data shifts.
